(19) United States
(12) Patent Application Publication
(10) Pub. No.: US 2015/0317148 A1
(43) Pub. Date: Nov. 5, 2015

(54) Apparatus for software product' upgrade and downgrade of electric equipment from web

(71) Applicant: Tadashi Ohashi, Sagamihara City (JP)

(72) Inventor: Tadashi Ohashi, Sagamihara City (JP)

(21) Appl. No.: 14/530,962

(22) Filed: Nov. 3, 2014

(30) Foreign Application Priority Data
May 1, 2014 (JP) 2014104710
May 1, 2014 (JP) 21400800078

(51) Int. Cl. G06F 9/445; G06F 9/44

(52) U.S. Cl. CPC G06F 8/65; G06F 8/71

(57) ABSTRACT

Electric equipment is very high-performance so that system sustainability tends to be downgraded. Once a user gets the system, it is very difficult to catch up with latest version of hardware functions and software products from marketplaces. To solve the problem, this upgrade and downgrade invention must be applied to electric equipment is able to access dynamically to hardware functions in the form of emulator and software products through web Linked Open Data (LOD). The invented means make it possible to upgrade or downgrade for the latest version or old version of hardware functions superseded by emulators and software products which are directly loaded into storage component like FPGA by means of web LOD. The system sustainability of proposed electric equipment with Linked Open Data can be performed by Sustainability Manager which deals with operating system, emulator, firmware and applications with results of software management information.

### TECHNICAL FIELD

Electric equipment hardware and software.

### BACKGROUND

Electric equipment like smartphone performs the today's important social structures. But the system sustainability is not taking into account. But recently, the system sustainability is little by little taking into account because of environment conservations and rational energy power consumption.

### SUMMARY

A hardware or software implemented in electric equipment is inevitably upgraded or downgraded for unnecessary functions or operations. In order to do so, a system upgrade or downgrade make systems feasible to satisfy users' upgrading demands as well as possible to users' request to keep higher and sustainable demands, and make systems feasible to sustain continuous social system and more rationale to save energy for natural resources conservations.

### BRIEF DESCRIPTION OF THE DRAWINGS

FIG. 1 is the overall constitution of this invention's embodiment for apparatus of software update for electric equipment from web.

FIG. 2 is the constitution diagram for this invention's embodiment SPMWm (ENDPOINT Server) of apparatus of software update for electronic equipment.

FIG. 3 is this invention's embodiment for internal hardware and software of the apparatus of software product's update.

FIG. 4 is the drawing of browser which shows operation flame for registrant and administrator.

FIG. 5 is the SPARQL (query language) sentence.

FIG. 6 is the principle diagram of SPARQL retrievable by triple.

FIG. 7 is the diagram for the triple which identify the performance conditions and software product's software product's data location on web.

FIG. 8 is the embodiment for logical decision making on web for software product's performance conditions.

FIG. 9 is the embodiment for logical decision making in FPGA of electric equipment for software product's performance conditions.

FIG. 10 is the connection diagram between web and FPGA.

FIG. 11 is the drawing for OSTLOD (Operating System Table of Linked Open Data).

FIG. 12 is the drawing for FWTLOD (Firmware Table of Linked Open Data).

FIG. 13 is the drawing for HETLOD (Hardware Emulator Table of Linked for Open Data).

FIG. 14 is the drawing for APTLOD (Applications Table of Linked Open Data)

FIG. 15 is the sequence diagram of producing SPEI (Software Product's Element Information) for Apparatus of software update for electric equipment from web.

FIG. 16 is the sequence diagram for detecting hardware and software version for Apparatus of software update for electric equipment from web.

FIG. 17 is the sequence diagram for controlling FPGA process by SPDMGR (Software Product Management in Device) for Apparatus of software update for electric equipment from web.

FIG. 18 is the sequence diagram for upgrading and downgrading for Apparatus of software update for electric equipment from web.

FIG. 19 is the diagram for embodiment of this invention's hardware for upgrading and downgrading for apparatus of software update for electric equipment from web.

FIG. 20 is the hardware configuration table for upgrading and downgrading for Apparatus of software update for electric equipment from web.

FIG. 21 is the software composition table for upgrading and downgrading for Apparatus of software update for electric equipment from web.

### DETAILED DESCRIPTION

This invention aims at offering for apparatus of software upgrade and downgrade for electric equipment from web. This patent is premised on system which consists of several Software Product Managers on Web. Each of them is prepared to process the following means for each Software Product Manager on Web storing means for element information in the form of RDF (Resource Description Framework) and OWL (Ontology Web Language), producing means for of element information which identifies attributes of storing information, transmitting means for which issue generated element information to another Software Product Manager on Web, receiving means for which receives SPAQL from another Software Product Manager on Web n to this Software Product Manager on Web n+1, issuing SPARQL to received Software Product Manager on Web n+1 by the above SPARQL receiving means, and retrieving means for requesting information of SPARQL by self-restoring means based on element information generated by the above producing means and being transferred by broadcasting from another Software Product Manager on Web n.

In system as written above, the element information by storing means for self-Software Product Manager on Web is shared by plural Software Product Managers on Web and plural electric equipment. Therefore, A given Software Product Manager on Web n in plural Software Product Managers on Web shared by element information. A query which requests information is issued as input to the effect that calls for information held in storing means for storing to another Software Product Manager on web.

Another Software Product Manager receives information corresponding to SPARQL acquires based on Product Manager on Web.

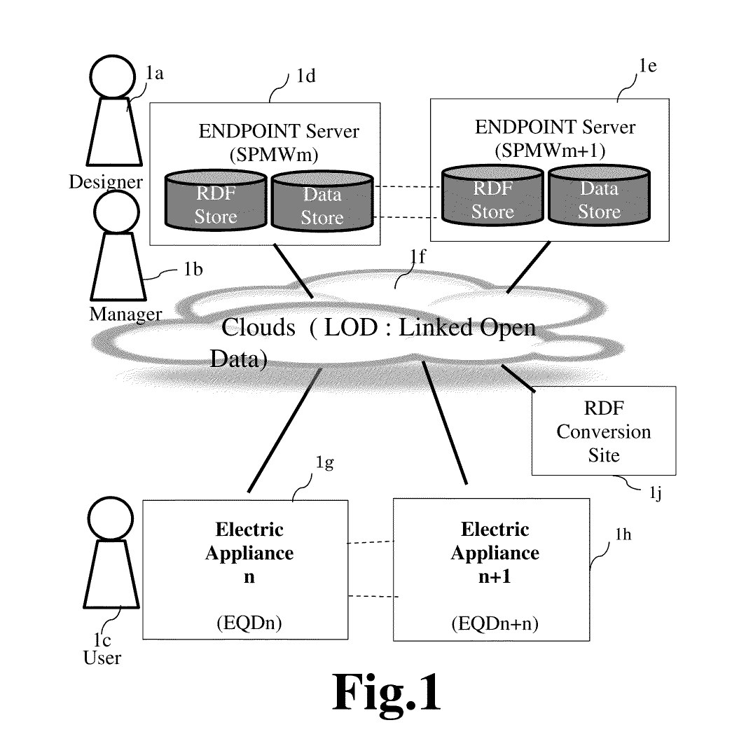

FIG. 1 shows overall constitution of the embodiment of this invention for either web system or electric equipment as means of software upgrade and downgrade for electric equipment. This invention system fulfills the necessary conditions on the part of maker side's registering means for web element information that a software product's registrant can register element information into RDF Store by means of SPMW(Software Product Management on web) of a given EPS(Endpoint Server). The registrant makes possible software products such as executable format register into Data Store. This invented system has two major merits. One of them consists of part of SPMW(Software Product Management on web) 1d˜e which becomes plural Software Product Manager on Web n and plural electric equipment 1g˜h. A registrant la namely developer or an administrator 1b on the side of software product makers belong to every Endpoint Server and a user 1c belongs to every electric equipment.

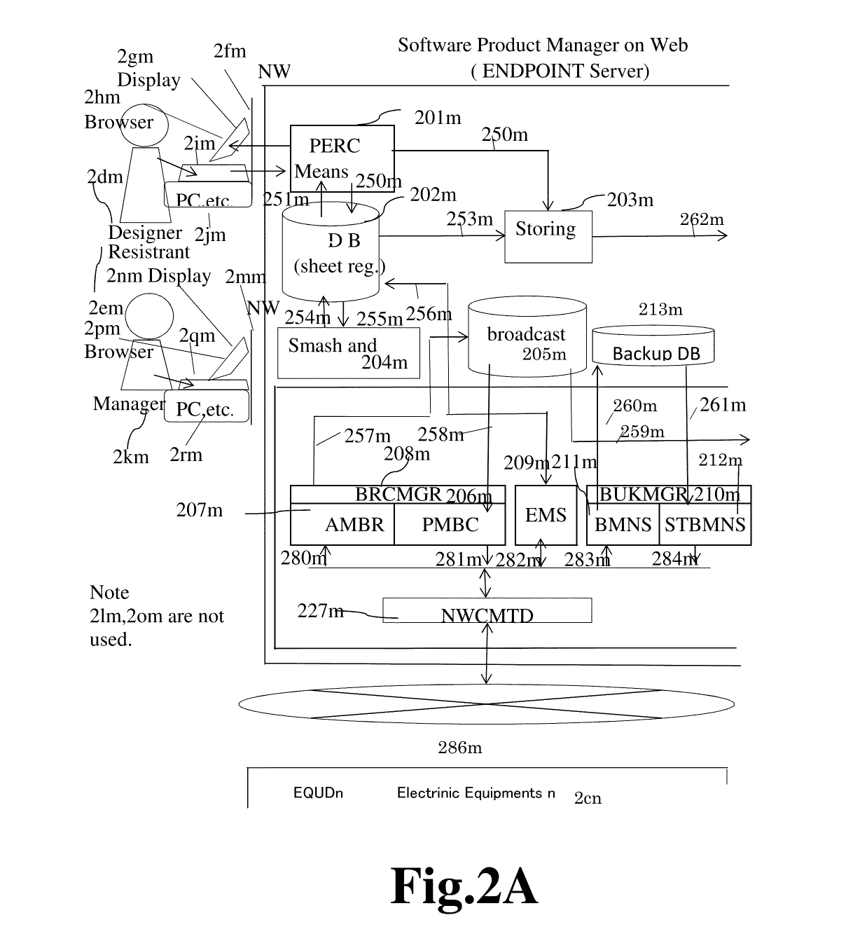

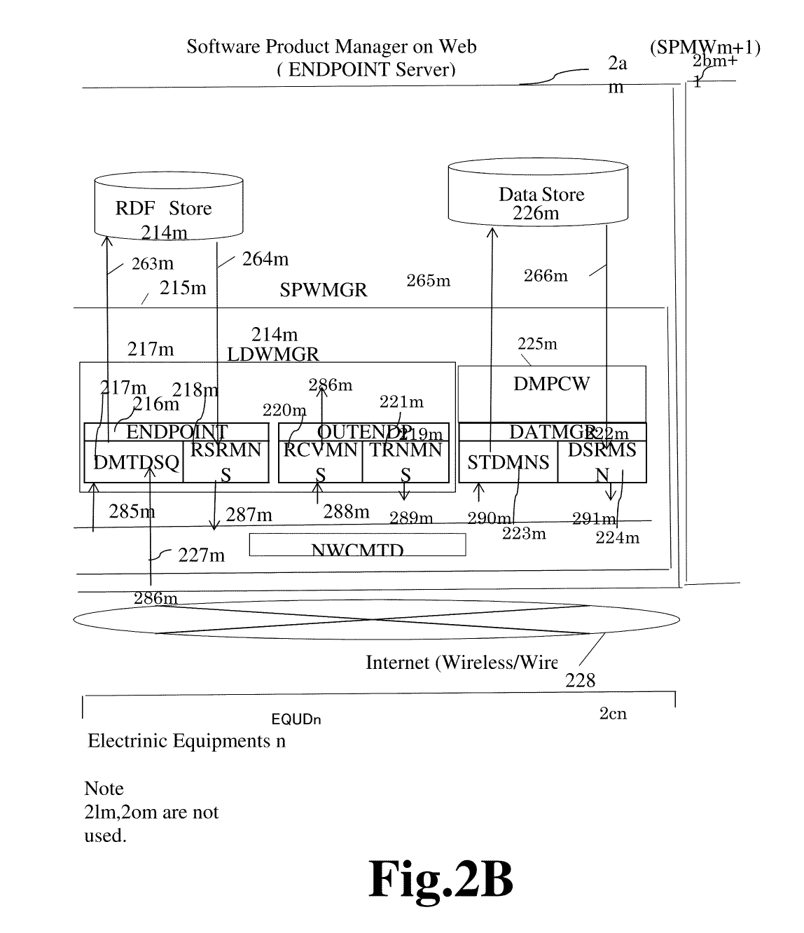

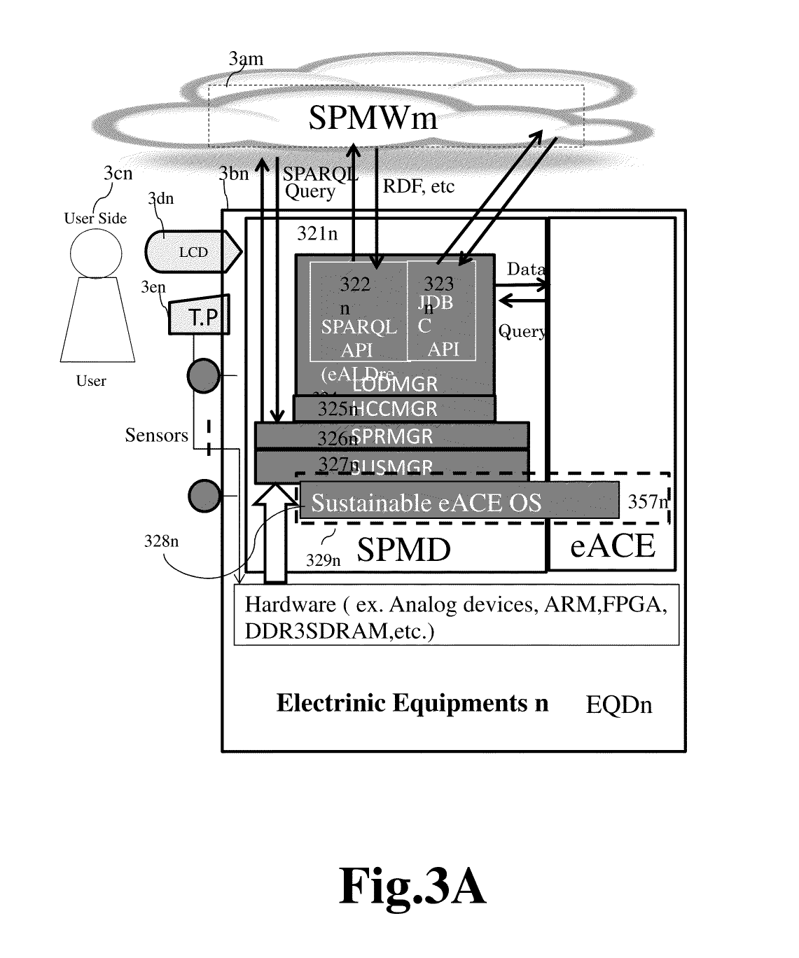

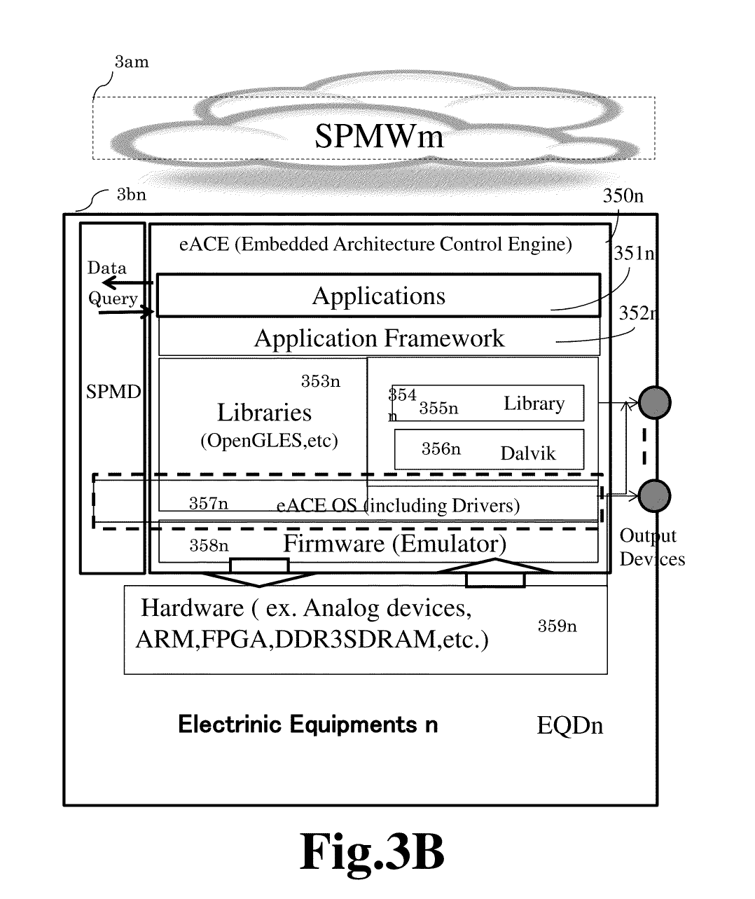

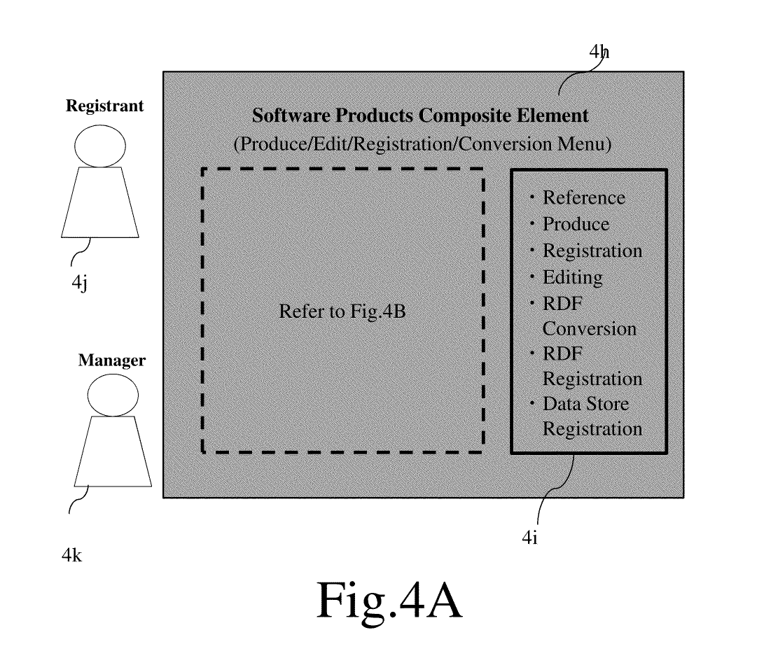

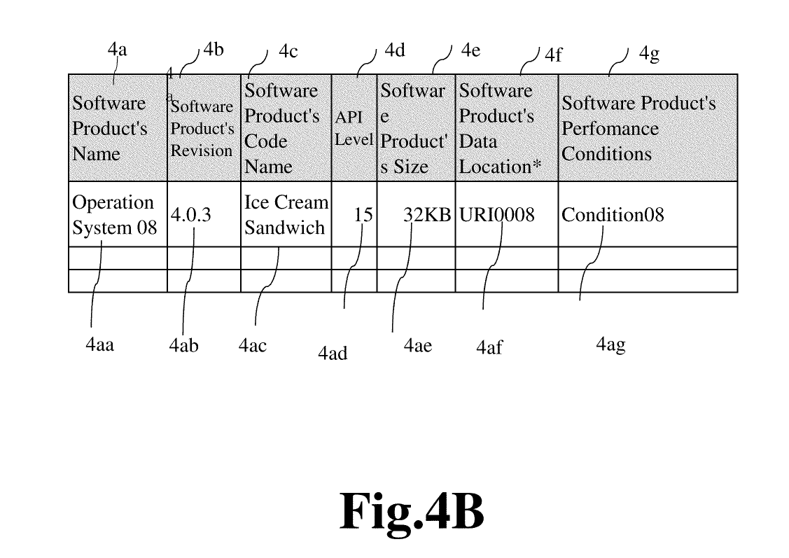

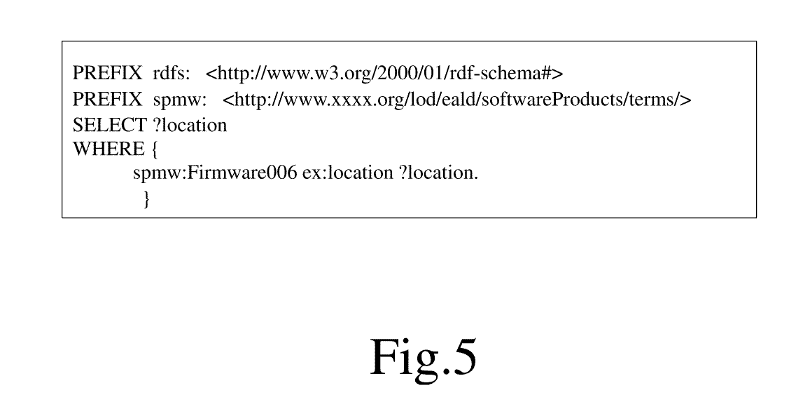

FIG. 2 shows internal configuration diagram of endpoint server (SPWM) 2am to produce and provide software product's element information for electric equipment. This invented system fulfills the necessary conditions of Linked Data retrieval means for retrieval processing means by SPARQL on web for current grade, upper grade or down grade to take advantage of registrants as well as administrators. This invented system has downloaded backup data of electric equipment up to Endpoint Server and storing Means for in Endpoint Server and downloading into internal Endpoint server. This invented system has SPARL decoding means for electric equipment on Endpoint Server and reply means for electric equipment by RDF, OWL (Ontology Web Language) and the like. If Software Product Manager on Web n cant find SPGI or SPEI, this invented system has alternative retrieval means for other Software Product Manager on Web n+a relying on pre-broadcasted URL. SPWMGR (Software Products on Web Manager) 215m controls internal leading functions. A producer 2dm and registrant 2em both of whom produces SPEI and registers them) produces Element Information Sheets FIG. 11, 12, 13, 14 using Produce/Edit/Registration Means for 201 through web browser FIG. 4 as shown in Display 2fm of personal computer 2jm for registrant and producer. A produced element information sheet is stored in Database for sheet registration. By operation of registrant and administrator, the element information is converted to RDF by means of RDF Conversion site 1a operated by externally serviced site FIG. 1 and is stored RDF store 214m. A user and an administrator can also store software product's entity (ex. Executable format) into Data store 226m through web browser FIG. 4 for editor. At this storing time, Software product's size is automatically stored into element information sheets. Through network, other registrant and administrator can manage element information by means of Exchange Means for Sheets (EMS) 209m. In FIG. 3, if user of electric equipment 3cn designates given software product's name and version by means of operation means for such as touch panel 3en or Liquid Crystal Display 3dn, a SPARQL FIG. 5 produced by electric equipment through wired or radio network internet 228 or the like is sent to FIG. 2 Entry-point 216m and retrieve RDF store 214m. There are many endpoints and broadcasted to every SPMWm by URL (Uniform Resource Locator) on web and the broadcasted data is transferred at the request of electric equipment at the power-on of each electric equipment 2cn and stored in each broadcast DB 205m. If no request by first self SPWm is found, SPARQL processing is continued by providing process means for other group and element information 218m and by URL request internally stored in endpoint. In case that upgrade or downgrade of a given electric equipment is performed, first of all decision means for performance condition on web 225m must be done to whither satisfy or not. If performance condition is satisfied, tables, data and so forth in electric equipment are stored in backup database 213m and are able to restore from backup database into original location as necessary.

FIG. 3 is shown as embodiment of this invention for example of hardware and software configuration drawings of electric equipment. The electric equipment fulfills the necessary conditions for acceptance means for user's selection and user's decision making of software product's current version, upgrade version or downgrade version of users electric equipment.

SPMWm has neighborhood retrieval for current, upgrade or downgrade by extracting triple of web based on software product's name, version and performance condition of given electric equipment using SPARQL. SPMWm can display possible upgrade and downgrade software product's name and version. And the user push start button for upgrade and downgrade if having conformed the results and selection. But if not satisfied, the retrieval is tried again. SPMWm has requesting and receiving means for broadcast by the nearest endpoint server when a given electric instrument is powered on. A user 3cn of electric instrument 3bn can operates by touch panel 3en as input means and by Liquid Chrystal Display 3dn as output means. The inside of electric equipment consist mainly of SPMD (Software Products Management in Device) 321n, eACE (embedded Architecture Control Engine) 350n and hardware such as analogue components like sensors, FPGA, DDR3SDRAM or other storage components. eACE can be possible using platform including general open source operating system. On the other hand, SPMD is cooperatively performed in conjunction with SPMWm on web. SPMD can make it possible to perform given electric equipment even if it is in the software product's upload and download including operating system. Because that SPMD has Sustainable S328n on which SUSMGR (Sustainable Manager) 327n controlling whole system SPMDn and SPRMGR (Software Products Manager) 326n managing whole system SPMDn, above all LODMGR (Linked Open Data Manager) 324n is designed. LODMGR is consist of API (Application Program Interface) 322n for SPAQL and JDBCAPI (Java Database Connectivity Application Program Interface) 323n. Prior to downloading, decision means for performance condition for electric equipment 325n checks whether condition is satisfied or not.

FIG. 4 is shown as web browser screen 4h for registrant or administrator. A registrant or designer on the part of maker side (developer of software products) produces element information sheet by means of producing means for web element information and stores them into database for sheet registration. This browser has a menu converting software products group and element information to RDF or OWL on behalf of free service on web sites. When registrant or administrator is revising or editing software product's element information, a given software product's name and version must be set in endpoint server. SPMWm has retrieval function to find revise object software products. In order to do so, it searches for RDF inside according to the above written claim 3, display the result. A registrant or administrator revises contents and resisters them into RDF store and Data store at the same time. This revision is broadcasted to transfer new products group and element information. A registrant 4j on the side of maker produces software products group and element information, and administrator edits 160 mashup. This frame mainly consist of several input cells 4aa˜4ag columns under title bar 4a˜4g. Operation menu 4i has Reference, Registration, Editing, RDF Conversion, RDF Registration, and Data Store Registration.

FIG. 5 shows SPAQL (SPARQL Protocol and RDF Query Language) sentence. The above written claim 3 shows that ENDPOINT server deals with SPARQL on behalf of registrant and administrator. Software products information are modelled by RDF using RDFs (RDF schema) and OWL (Ontology Web Language) and stored in RDF and Software products data is stored in Data store. This model is embodied by using SPAQL to form the invention. To practice, with reference to documents, a question is set variables as unknown variable. As SPARQL, questionnaire is set as involved as RDF model including these variables. The SPARQL retrieves URI (Uniform Resource Identifiers) and literal value in accordance with these variables. In reference with documents, each label is explained. URI (half width characters) is as qualified name. { } (half width characters) is a graph pattern including variables. WHERE (half width characters) identifies graph's location. SELECT denotes variable extracting object. And last? (Half width characters) is used as prefix symbol of unknown variable. On the electric equipment, SPARQL scripting software product's name and version is produced to retrieve Linked Data for endpoint servers.

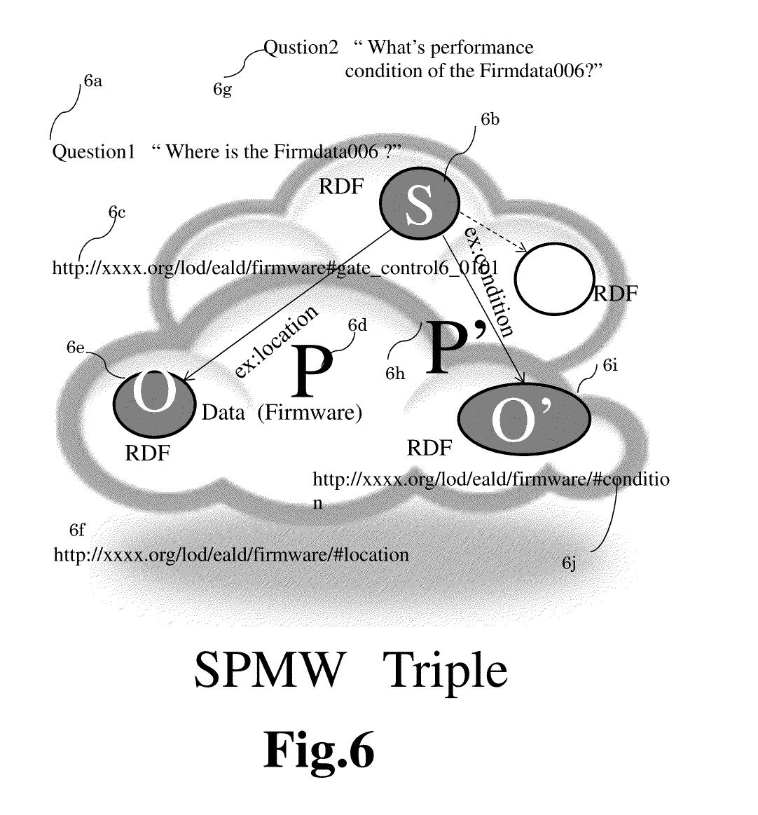

As described in FIG. 1, http://www.w3.org/TR/2013/REC-sparql11-overview-20130321/ is picked up as example. This retrieval is based on the principle of triple as described in FIG. 6, by setting a given software product's name and version, the invented system retrieves software products group and element information for upgrade or downgrade, software product's size, location and performance condition are retrieved.

FIG. 6 is shown as the principle of retrieval based on triple designating software product's location, size and location. In this example, For Query 6a shows where Firmdata006 is stored, endpoint 216 searches location 6e as shown in endpoint server 6e. In this FIG. 6, software product's size and performance condition 6g are similarly retrieved using triple.

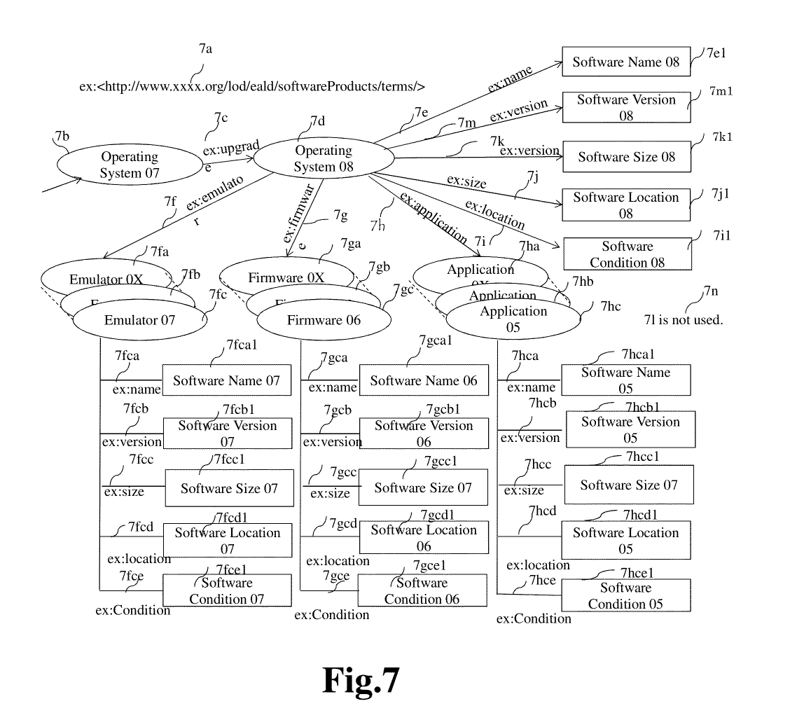

FIG. 7 shows hierarchical ontology for software products group and element information. In above FIG. 6, triple is organized by RDF or OWL on web as inter-related software products group and element information. An endpoint server can acquire the ontology as result of accepting upgrade retrieval or downgrade retrieval requests based on software products name and version.

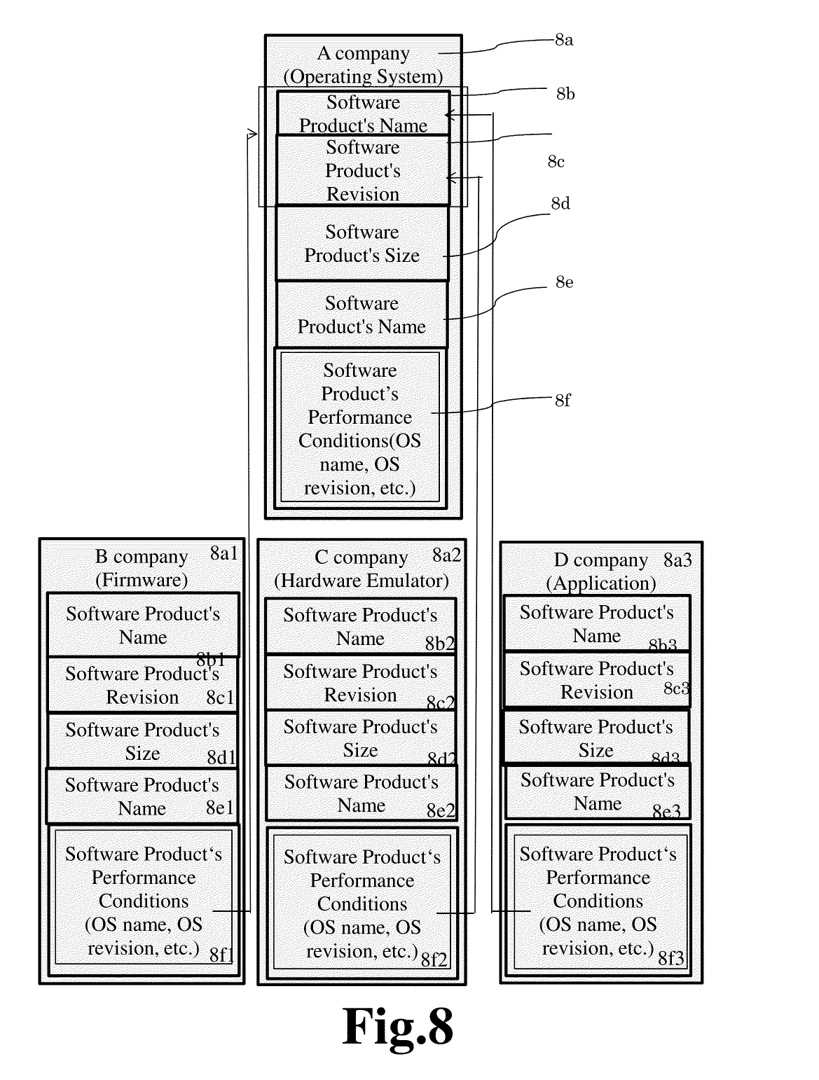

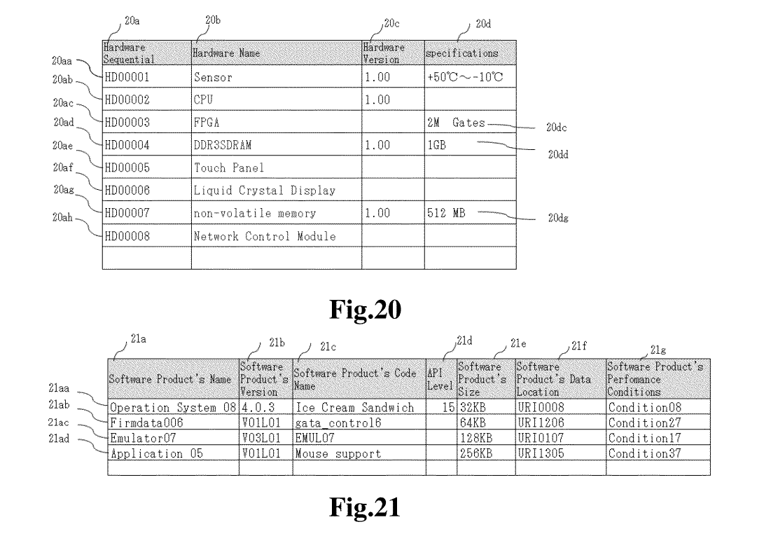

FIG. 8 shows explanation for software product's performance condition on web. To perform software products, given software and hardware product's performance conditions must be satisfied. Hardware Composition Table is shown in FIG. 20 and Software Composition Table is similarly shown in FIG. 21.

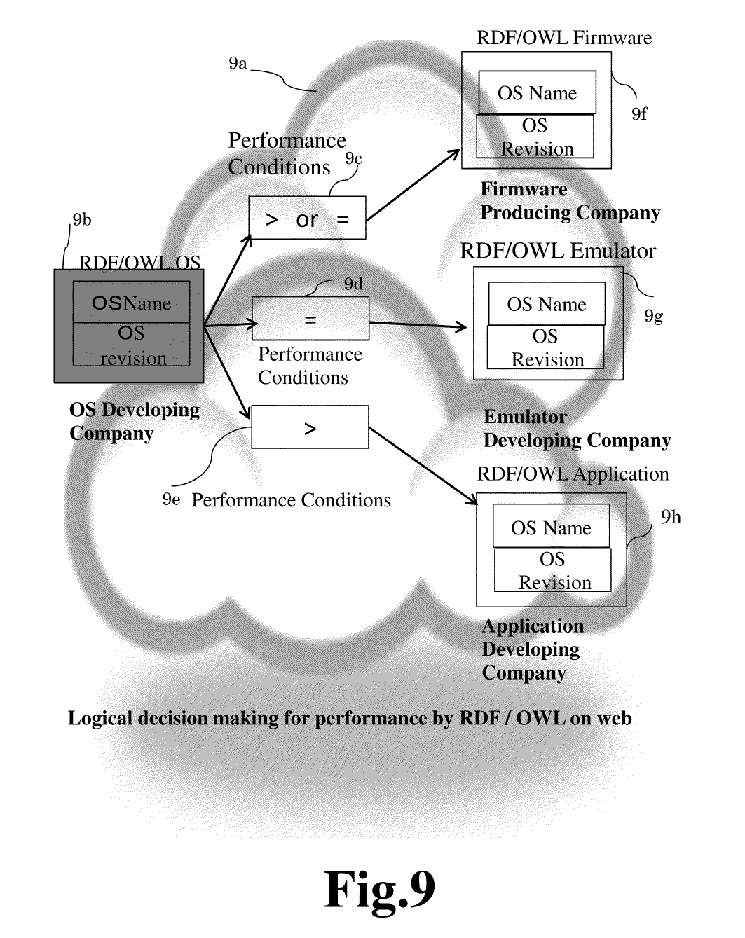

FIG. 21 shows each software product's performance condition. FIG. 9 is an example of logical decision for software product's performance conditions. This means is decision whether emulator's performance condition 9g, firmware condition and application side's performance conditions performance 9h are satisfied or not when current operating system 9b is updated. If satisfied, SPARQL make it decision for performance conditions on web before True returning Boolean is issued and downloading is persecuted. And it makes possible compatibility of electric equipment. Therefore it makes possible to stop degradation of performance quality beforehand.

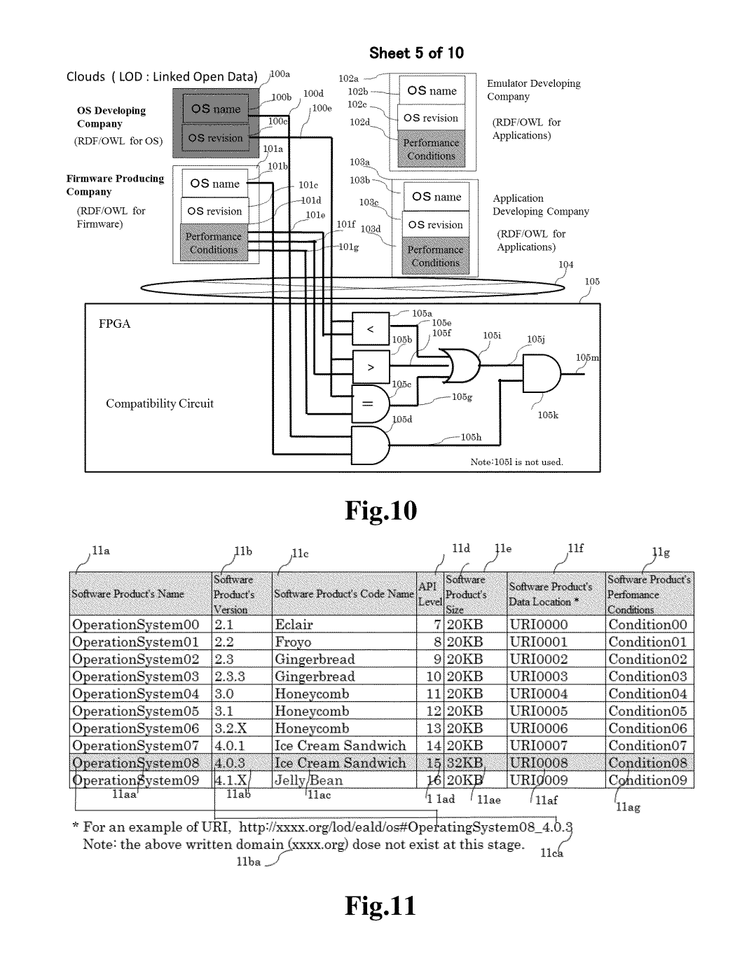

FIG. 10 shows an example of the logical decision making whether software products performance Is satisfied or not by FPGA in given electric equipment. When software product's upgrade or downgrade is executed, Compatibility logic is not performed by software but performed by hardware such as FPGA equipped in electric equipment. Hardware Composition Table and Software Composition Table are loaded into FPGA for examining compatibility. As result, Compatibility logic can be executed as fast as possible for various kinds of applications.

FIG. 11 is shown as OSTLOD (Operating System Table of Linked Open Data). Column name e is also available. The unique information is managed by software product's name and version for real producing target. A registrant 2dm/2em and administrator 2km as software product's developer stores this table into Database for sheet registration 202m and maintains them.

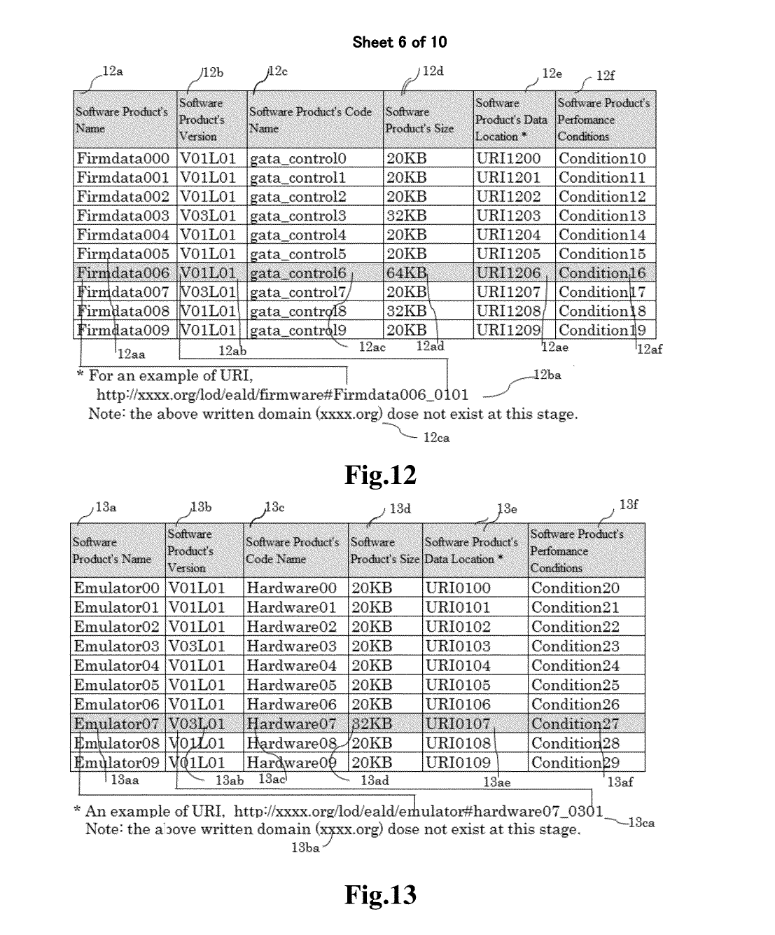

FIG. 12 is shown as FWTLOD (Firmware Table of Linked Open Data). Hereafter is same as above description of FIG. 11. FIG. 13 is shown as HETLOD (Hardware Emulator Table of Linked for Open Data). Hereafter is same as above description of FIG. 11. Performance conditions are exemplified as follows.

<rdfs:domain rdf:resource=“#Version4.0.1”/>

<rdfs:range rdf:resource=“#Version4.1.x”/>

These performance conditions are verified on web or in FPGA.

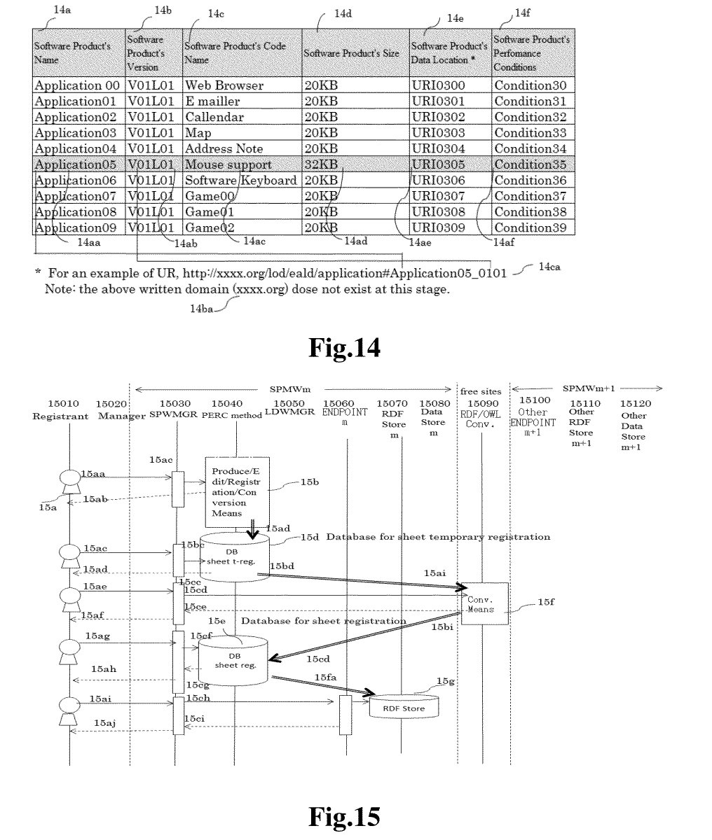

FIG. 14 is shown as APTLOD (Applications Table of Linked Open Data). Hereafter is same as above description of FIG. 11.

FIG. 15 is shown as sequence diagram of producing SPEI (Software Product's Element Information) for Apparatus of software update for electric equipment from web. A registrant 15a produces SPEI based on software product's name and version by operation frame delivered by SPMWm server as shown in FIG. 4 which makes it possible to produce SPGI. This SPGI is stored into sheet database 15d by designating performance condition and actions to store them. When software product's entity (ex. executable data) is registered into a given data store 15h, software product's size and its data location are added to the described above software products group information SPGI. Furthermore as LOD, In order to register SPGI into RDF store, SPGI is converted into RDF date by a free RDF conversion site 15f. When first of all, RDF conversion item is clicked in FIG. 4, and RDF registration item is clocked, then RDF conversion data is stored into RDF store.

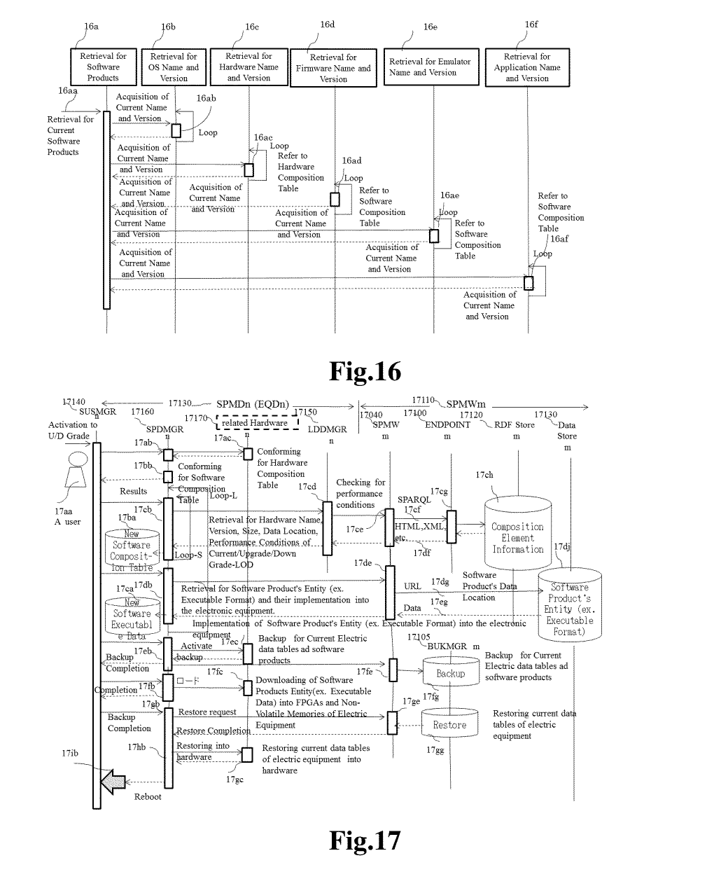

FIG. 16 is shown as sequence diagram for detecting really-packaged hardware and software components of the apparatus for which software product' upgrade and downgrade of electric equipment from web are executed. This sequence diagram has means for software products Group information and element information on the part of electric equipment.

FIG. 17 is shown as sequence diagram that software product's upgrade and downgrade of electric equipment from web are executed to electric equipment.

This apparatus has the backup means of data and table stored in given electric equipment and this backed-up data is put on web. First of all, a user select upgrade or downgrade, electric equipment EQDn confirms current hardware composition table 17ac and confirms current software composition table 17bb. This is intended to upgrade Operating System Version from Operating System07 to Operating System08 as shown in FIG. 11. Then LDDMGR produces question sentence (SPARQL) for upgrading upper version and sent to endpoints. In the sequel, based on the combination between semantic engineering of FIG. 6 and Ontology engineering of FIG. 7, this apparatus can retrieve upper version's RDF or lower version's RDF, and can interconnect them and totally get upper version's SPGI (XML/JSON/etc.) 17df or lower version's SPGI (XML/JSON/etc.) 17df from RDF store SPMw or SPMWm+1 as shown in FIG. 1.

The performance conditions of retrieved SPGI are logically verified by web compatibility vilification as shown in FIG. 9. The new software composition table is produced by storage components 17ba in electric equipment EQDn. Upper or lower version's software product's entity (ex. executable format) by having retrieved upper or lower software product's data location is stored in storage component 17ca. All current data and tables stored in storage components are stored in backup database 213m in FIG. 2 when all upper or lower version software products are retrieved by current software composite table 17bb. All necessary operating system, firmware, emulators or applications are downloaded from new software executable data 17ca to necessary storage components. In the next, all data and tables backed-up in backup database 213m are restored into necessary storage component 17gc. Then given electric equipment EQDn is re-booted 17i.

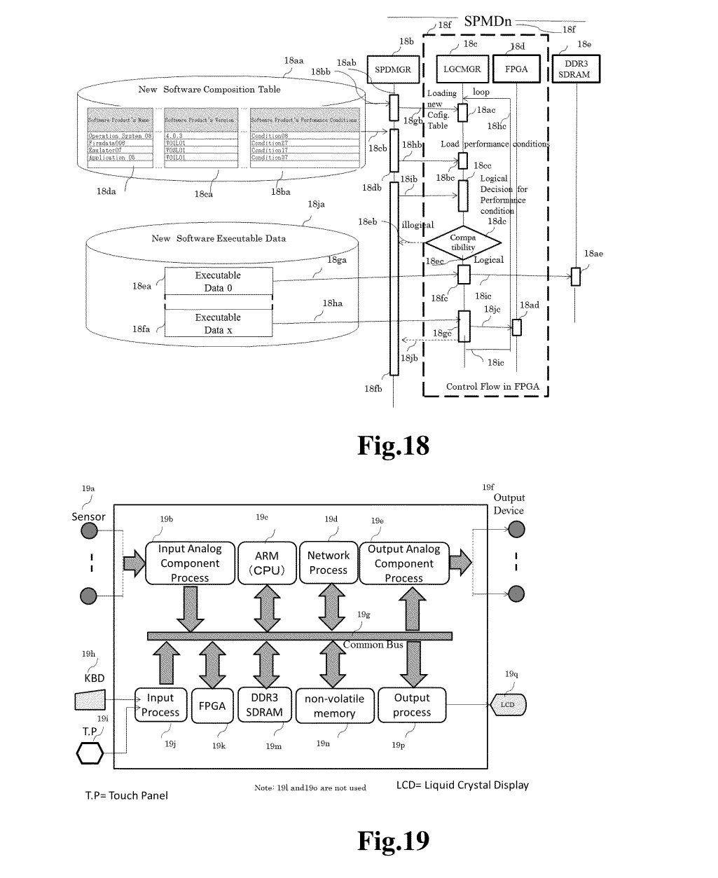

FIG. 18 shows sequence diagram that upgrade or downgrade of electric equipment are performed from web to FPGA. Decision means for available compatibility checked by software product's size and conditions for upgrade and downgrade on the side of electric user upgrade and downgrade are performed. As results, this apparatus has display means whether upgrade or downgrade is possible or not. After all, all has been done as written above, upgrade or downgrade from web resource to FPGA in electric equipment can be possible.

FIG. 17 shows detail sequence diagram for upgrade and downgrade as described 17gc. Stored new software composite table 17ba and each of new software executable data are downloaded into pre-assigned and permitted writable area of FPGA 18ac, 18bc. Each of new software products is logically verified by performance condition by compatibility circuit gate in FPGA of FIG. 10. If no contradiction is admitted, each of them is loaded into storage components such as FPGA.

All software products are downloaded by loop process 18ic.

FIG. 19 is shown as figure of hardware constitution of electric equipment.

All software products with respect to this invention, all of operating system, firmware (including gate data),emulator, applications and sustainable operating system and SPMD data are supplied as follows. First of all, all of the above written data are preinstalled in non-volatile memory 19n. These data are transferred to FPGA 19k and DR3SDRAM 19m when power is on. In this case, necessary software products are partially preinstalled when electric equipment is shipped to customer or users. On the other hand, from network such as wed part of software products are downloaded into FPGA 19k and DDR3SDRAM 19n and executed. Software products basically are installed in storage components DDR3SDRAM. Network process 19d in electric equipment communicates SPMW. Firmware (gate data) is installed in FPGA 19k.

FIG. 20 is hardware composition table for software product's upgrade and downgrade of electric equipment from web. Essentially electric equipment has means to set up latest hardware composition table when electric equipment has installed at customer. Electric equipment has current hardware composition table and display that shows updated hardware composition according to user's upgrade and down grade selection.

FIG. 21 is software composition table for software product's upgrade and downgrade of electric equipment from web. Similarly electric equipment has means to set up latest software composition table when electric equipment has installed at customer.

What is claimed is:

1. An apparatus has means that software composition hierarchy of electric equipment is explained by ontology for software products group information including software product element information such as software product name, version, performance conditions, program size and software product's entity (ex. executable format) as software product's element data are put on web, these elements are interconnected as LOD (Linked Open Data) by RDF (Resource Description Framework) or OWL (Ontology Web Language), has means that whole or part of hardware of electric equipment can be superseded by firmware stored in storage component such as FPGA (Field Programming Gate Array), has means that make it possible to upgrade or downgrade of system through Linked Open Data by endpoint server handling question sentence such as SPARQL, has means that system compatibility to verify logical performance conditions between necessary software elements on the side of web or in the side of electric equipment, has means that software products are downloaded into electric equipment and has means that software product's upgrade or downgrade from web to electric equipment using means to reconfiguration whole or part of electric equipment's software instead of backup data originally installed software products on web.

2. The apparatus of claim 1, wherein the apparatus is for software product upgrade and downgrade of electric equipment from web as described in claim 1 and the above written software products group and element information are scripted by RDF(Resource Description Framework), OWL (Ontology Web Language) or the like expressing software product's name, version, size, performance conditions and software product's data location.

3. The apparatus of claim 1, wherein this system has software performance conditions on both side of web and electric equipment. Performance conditions are hardware compatibility which verifies version (function) of upper/lower software products such as operating system. Endpoint server has reading function of SPARQL for upper or lower version of software products not only self-retrieving of self-endpoint server and but also has requesting function for other endpoint server by the same SPARQL sentence. As result of retrieval, capturing data is not only the same data format as registered beforehand but also other formats such as (xml or json or the like) can be supplied to requested server. This invented question sentence using SPARQL can retrieve possible upgrade or downgrade versions, software product size, data location, performance conditions based on given software product name and version.
